(19) United States
(12) Patent Application Publication
(10) Pub. No.: US 2017/0170651 A1
(43) Pub. Date: Jun. 15, 2017

(54) PROTECTION CIRCUIT AND DEVICE FOR HDMI IDENTIFICATION PORT

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Wei DUAN, Tianjin (CN)

(21) Appl. No.: 15/250,542

(22) Filed: Aug. 29, 2016

Related U.S. Application Data
(63) Continuation of application No. PCT/CN2016/088429, filed on Jul. 4, 2016.

(30) Foreign Application Priority Data
Dec. 15, 2015 (CN) 201521054659.1

(51) Int. Cl. H02H 7/20

(52) U.S. Cl. CPC H02H 7/20

(57) ABSTRACT

A protection circuit for an HDMI identification port and a device having the same. The protection circuit includes a first switch circuit and a second switch circuit, wherein one end of the first switch circuit is connected to an HDMI power port, and the other end of the first switch circuit is connected to the second switch circuit; one end of the second switch circuit is connected to the first switch circuit and the other end of the second switch circuit is connected to the HDMI identification port; and the first switch circuit isolates a voltage loaded to the HDMI power port, and drives the second switch circuit to be conducted and uses a standby voltage as an identification voltage of the HDMI identification port.

### CROSS-REFERENCE TO RELATED APPLICATIONS

This application is a continuation of PCI Application No. PCT/CN2016/088429 filed on 4 Jul. 2016, and is based upon and claims priority to Chinese Patent Application No. 201521054659.1, filed before Chinese Patent Office on 15 Dec. 2015 and entitled “PROTECTION CIRCUIT AND DEVICE FOR HDMI IDENTIFICATION PORT”, the entire contents of which are incorporated herein by reference.

### TECHNICAL FIELD

The present disclosure relates to the technical field of HDMI, and more particularly, to a protection circuit for an HDMI identification port and a device having the same.

### BACKGROUND

A high definition multimedia interface (HDMI) is a digital video/audio interface technology, and is a dedicated digital interface suitable for image transmission. The HDMI is capable of transferring both audio signals and image signals, with a maximum data transmission rate of 4.5 GB/s. In addition, the HDMI does not need a digital-analog or analog-digital conversion before transferring signals, which may be incorporated with high-bandwidth digital content protection (HDCP) to prevent audio and video content granted with copyrights from unauthorized duplications. Therefore, the HDMI has been extensively applied in various electronic devices.

With respect to such an electronic device as a television, typically an HDMI identification port (ident Pin) is employed to detect whether an identification voltage (5 V) is present at an HDMI power port (Pin 18), to thus judge whether the electronic device is externally connected to a signal source. The electronic device displays image content only when the electronic device is externally connected to a signal source and the signal is available.

However, the HDMI signal source provided in such usage scenarios as household appliance markets is not standard, and voltages of many signal sources are much higher than the standard identification voltage (5 V). As a result, the chip in the electronic device connected to the identification port may be easily damaged. In addition, conventional protection circuits for an HDMI identification port are mostly electrostatic discharge (ESD) protection circuits, which fail to provide protection for too high direct-current voltages.

Therefore, it is a technical problem to be solved urgently in the related art as how to perform overvoltage protection for an identification port.

### SUMMARY

In view of the above, the present disclosure provides a protection circuit for an HDMI identification port and a device having the same. The protection circuit performs overvoltage protection for the HDMI identification port. This avoids damages caused to the device due to an over-high voltage of an HDMI signal source, and lowers the after-sale cost.

Embodiments of the present disclosure provide a protection circuit for an HDMI identification port, wherein the protection circuit includes a first switch circuit and a second switch circuit; wherein

one end of the first switch circuit is connected to an HDMI power port, and the other end of the first switch circuit is connected to the second switch circuit;

one end of the second switch circuit is connected to the first switch circuit and the other end of the second switch circuit is connected to the HDMI identification port; and

the first switch circuit isolates a voltage loaded to the HDMI power port, and drives the second switch circuit to be conducted and uses a standby voltage as an identification voltage of the HDMI identification port.

Embodiments of the present disclosure provide a device having an HDMI identification port, wherein the HDMI identification port is connected to the protection circuit as defined in claim 1, and the protection device includes a first switch circuit and a second switch circuit; wherein

one end of the first switch circuit is connected to an HDMI power port, and the other end of the first switch circuit is connected to the second switch circuit;

one end of the second switch circuit is connected to the first switch circuit and the other end of the second switch circuit is connected to the HDMI identification port; and

the first switch circuit isolates a voltage loaded to the HDMI power port, and drives the second switch circuit to be conducted and uses a standby voltage as an identification voltage of the HDMI identification port.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a circuit diagram illustrating a protection circuit for an HDMI identification port according to some embodiments of the present disclosure.

### DETAILED DESCRIPTION

A protection circuit according to the present disclosure connects a first switch circuit and a second switch circuit between an HDMI power port and an HDMI identification port. The first switch circuit isolates a voltage loaded to the HDMI power port, and drives the second switch circuit to be conducted and uses a standby voltage as an identification voltage of the HDMI identification port. Therefore, the protection circuit according to the present disclosure performs overvoltage protection for the HDMI identification port. This avoids damages caused to the device due to an over-high voltage of the HDMI signal source, and lowers the after-sale cost.

Definitely, the implementation of any technical solution of the present disclosure does not need to achieve all the above advantages.

To make a person skilled in the art better understand the technical solutions of the present disclosure, the technical solutions in the embodiments of the present disclosure are described clearly and completely with reference to the accompanying drawings in the embodiments of the present disclosure. Apparently, the described embodiments are merely some of rather than all of the embodiments of the present disclosure. Based on the embodiments of the present disclosure, all other embodiments derived by a person of ordinary skill in the art shall fall within the protection scope of the present disclosure.

Specific implementations of the present disclosure are further described hereinafter with reference to the accompanying drawings of the present disclosure.

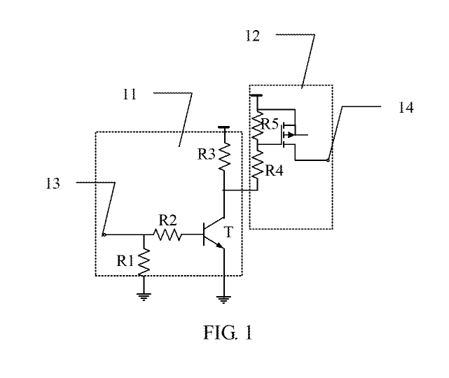

Referring to FIG. 1, a specific embodiment of the present disclosure provides a protection circuit for an HDMI identification port, wherein the protection circuit includes a first switch circuit 11 and a second switch circuit 12.

One end of the first switch circuit 11 is connected to an HDMI power port 13, and the other end of the first switch circuit is connected to the second switch circuit 12.

One end of the second switch circuit 12 is connected to the first switch circuit 11 and the other end of the second switch circuit is connected to the HDMI identification port 14.

The first switch circuit 11 isolates a voltage loaded to the HDMI power port 13, and drives the second switch circuit 12 to be conducted and uses a standby voltage as an identification voltage of the HDMI identification port 14.

Therefore, when the voltage loaded to the HDMI power port 13 is too high, no damage is caused to the chip connected to the HDMI identification port 14, and meanwhile a loaded standby voltage (5 V) ensures that the HDMI identification port 14 identifies whether a signal source is received.

Referring to FIG. 1, the first switch circuit 11 according to another specific embodiment of the present disclosure includes a switch transistor triode T, wherein a base of the switch triode T is connected to the HDMI power port 13, an emitter of the switch triode T is grounded, and a collector of the switch triode T is connected to the standby voltage (5 V).

To prevent a suspension voltage from causing malfunction of the switch triode T, the first switch circuit 11 further includes a first resistor R1, wherein a first end of the first resistor R1 is connected to the base of the switch triode T, and a second end of the first resistor R1 is grounded.

The first switch circuit 11 further includes a second resistor R2, wherein a first end of the second resistor R2 is connected to the base of the switch triode T, and a second end of the second resistor R2 is connected to the HDMI power port 13 and the first end of the first resistor R1 respectively. The second resistor R2 acts as a pull-down resistor, which ensures stability of operation of the switch triode T.

The first switch circuit 11 further includes a third resistor R3, wherein a first end of the third resistor R3 is grounded, and a second end of the third resistor R3 is connected to the collector of the switch triode T and the second switch circuit 12. The third resistor R3 acts as a bias resistor, which provides a suitable current by means of current limiting to the collector of the switch triode T.

The second switch circuit 12 includes a MOS field-effect transistor, wherein a gate of the MOS field-effect transistor is connected to the first switch circuit 11 and the standby voltage (5 V) respectively, a drain of the MOS field-effect transistor is connected to the standby voltage (5 V) and the gate of the MOS field-effect transistor, and a source of the MOS field-effect transistor is connected to the HDMI identification port 14.

To protect the MOS field-effect transistor, the second switch circuit 12 further includes a fourth resistor R4, wherein a first end of the fourth resistor R4 is connected to the first switch circuit 11, and a second end of the fourth resistor R4 is connected to the gate of the MOS field-effect transistor and grounded respectively.

To protect the MOS field-effect transistor, the second switch circuit 12 further includes a fifth resistor R5, wherein a first end of the fifth resistor R5 is grounded, and a second end of the fifth resistor R5 is connected to the gate of the MOS field-effect transistor and the second end of the fourth resistor R4 respectively.

Corresponding to the above described protection circuit for an HDMI identification port, the present disclosure further provides a device having an HDMI identification port, wherein the HDMI identification port is connected to any one of the above described protection circuits.

Although the embodiments of the present disclosure are described above, once knowing the basic creative concept, a person skilled in the art can make other modifications and variations to these embodiments. Therefore, the appended claims are intended to be construed as covering the embodiments and all the modifications and variations falling within the scope of the present disclosure. Obviously, a person skilled in the art can make various modifications and variations to the present disclosure without departing from the spirit and scope of the present disclosure. In this way, the present disclosure is intended to cover the modifications and variations if they fall within the scope of the appended claims of the present disclosure and equivalent technologies thereof.

What is claimed is:

1. A protection circuit for an HDMI identification port, the protection circuit comprising a first switch circuit and a second switch circuit; wherein
one end of the first switch circuit is connected to an HDMI power port, and the other end of the first switch circuit is connected to the second switch circuit;
one end of the second switch circuit is connected to the first switch circuit and the other end of the second switch circuit is connected to the HDMI identification port; and
the first switch circuit isolates a voltage loaded to the HDMI power port, and drives the second switch circuit to be conducted and uses a standby voltage as an identification voltage of the HDMI identification port.

2. The protection circuit according to claim 1, wherein the first switch circuit comprises a third switch triode, wherein a base of the switch triode is connected to the HDMI power port, an emitter of the switch triode is grounded, and a collector of the switch triode is connected to the standby voltage.

3. The protection circuit according to claim 2, wherein the first switch circuit further comprises a first resistor, wherein a first end of the first resistor is connected to the base of the switch triode, and a second end of the first resistor is grounded

4. The protection circuit according to claim 3, wherein the first switch circuit further comprises a second resistor, wherein a first end of the second resistor is connected to the base of the switch triode, and a second end of the second resistor is connected to the HDMI power port and the first end of the first resistor.

5. The protection circuit according to claim 4, wherein the first switch circuit further comprises a third resistor, wherein a first end of the third resistor is grounded, and a second end of the third resistor is connected to the collector of the switch triode and the second switch circuit.

6. The protection circuit according to claim 1, wherein the second switch circuit comprises a field-effect transistor, wherein a gate of the field-effect transistor is connected to the first switch circuit and the standby voltage respectively, a drain of the field-effect transistor is connected to the standby voltage and the gate of the field-effect transistor, and a source of the field-effect transistor is connected to the HDMI identification port.

7. The protection circuit according to claim 6, wherein the second switch circuit further comprises a fourth resistor, wherein a first end of the fourth resistor is connected to the first switch circuit, and a second end of the fourth resistor is connected to the gate of the field-effect transistor and grounded.

8. The protection circuit according to claim 7, wherein the second switch circuit further comprises a fifth resistor, wherein a first end of the fifth resistor is grounded, and a second end of the fifth resistor is connected to the gate of the field-effect transistor and the second end of the fourth resistor.

9. A device having an HDMI identification port, wherein the HDMI identification port is connected to the protection circuit as defined in claim 1, wherein the protection device comprises a first switch circuit and a second switch circuit: wherein
one end of the first switch circuit is connected to an HDMI power port, and the other end of the first switch circuit is connected to the second switch circuit;
one end of the second switch circuit is connected to the first switch circuit and the other end of the second switch circuit is connected to the HDMI identification port; and
the first switch circuit isolates a voltage loaded to the HDMI power port, and drives the second switch circuit to be conducted and uses a standby voltage as an identification voltage of the HDMI identification port.

10. A device having an HDMI identification port, wherein the HDMI identification port is connected to the protection circuit as defined in claim 9, wherein the first switch circuit comprises a third switch triode, wherein a base of the switch triode is connected to the HDMI power port, an emitter of the third switch triode is grounded, and a collector of the switch triode is connected to the standby voltage.

11. A device having an HDMI identification port, wherein the HDMI identification port is connected to the protection circuit as defined in claim 10, wherein the first switch circuit further comprises a first resistor, wherein a first end of the first resistor is connected to the base of the switch triode, and a second end of the first resistor is grounded.

12. A device having an HDMI identification port, wherein the HDMI identification port is connected to the protection circuit as defined in claim 11, wherein the first switch circuit further comprises a first resistor, wherein a first end of the first resistor is connected to the base of the switch triode, and a second end of the first resistor is connected to the HDMI power port and the first end of the first resistor respectively.

13. A device having an HDMI identification port, wherein the HDMI identification port is connected to the protection circuit as defined in claim 12, wherein the first switch circuit further comprises a third resistor, wherein a first end of the third resistor is grounded, and a second end of the third resistor is connected to the collector of the switch triode and the second switch circuit.

14. A device having an HDMI identification port, wherein the HDMI identification port is connected to the protection circuit as defined in claim 9, wherein the second switch circuit comprises a field-effect transistor, wherein a gate of the field-effect transistor is connected to the first switch circuit and the standby voltage, a drain of the field-effect transistor is connected to the standby voltage and the gate of the field-effect transistor, and a source of the field-effect transistor is connected to the HDMI identification port.

15. A device having an HDMI identification port, wherein the HDMI identification port is connected to the protection circuit as defined in claim 14, wherein the second switch circuit further comprises a fourth resistor, wherein a first end of the fourth resistor is connected to the first switch circuit, and a second end of the fourth resistor is connected to the gate of the field-effect transistor and grounded.

16. A device having an HDMI identification port, wherein the HDMI identification port is connected to the protection circuit as defined in claim 15, wherein the second switch circuit further comprises a fifth resistor, wherein a first end of the fifth resistor is grounded, and a second end of the fifth resistor is connected to the gate of the field-effect transistor and the second end of the fourth resistor.
